(19) United States
(12) Patent Application Publication
(10) Pub. No.: US 2021/0204566 A1
(43) Pub. Date: Jul. 8, 2021

(54) FERMENTED VEGETABLE PROTEIN COMPOSITIONS AND METHODS FOR PRODUCING THE SAME

(71) Applicant: CARGILL INCORPORATED, Wayzata, MN (US)

(72) Inventors: Eric BELL, Blair, NE (US); Keith Mertz, Blair, NE (US); Eugene Max PETERS, JR., Kettering, OH (US); Fabio SOLLER, Bennington, NE (US); Anton WOO, Tipp City, OH (US); Hadi Nayef YEHIA, Beavercreek, OH (US)

(73) Assignee: CARGILL INCORPORATED, Wayzata, MN (US)

(21) Appl. No.: 16/065,256

(22) PCT Filed: Dec. 22, 2016
(86) PCT No.: PCT/US2016/068194

§ 371 Date: Jun. 22, 2018

Related U.S. Application Data
(60) Provisional application No. 62/271,047, filed on Dec. 22, 2015.

(51) Int. Cl. A23K 20/147; A23K 20/26; A23K 20/105; A23K 20/163; A23K 10/12; A23K 50/80

(52) U.S. Cl. CPC A23K 20/147; A23K 20/26; A23K 50/80; A23K 20/163; A23K 10/12; A23K 20/105

(57) ABSTRACT

The present invention relates to animal feed ingredients and products, methods of producing such ingredients and products, and feed diets containing such ingredients and products. In one aspect, the present invention relates to a fermented vegetable protein (FVP) ingredient or product. Accordingly, the feed ingredient or product of the present invention can include one or more organic acids and is rich in amino acids. In one aspect, the feed ingredient can be produced using a fermentation process, for example through the fermentation of a corn mill stream such as light steep water. In one aspect, the present invention relates to feed products combining the feed ingredient with other components. The feed ingredients and products described herein are particularly useful for aquaculture, such as fanned shrimp.

### CROSS-REFERENCE TO RELATED APPLICATIONS

This application claims priority to U.S. Provisional Patent Application No. 62/271,047, filed on Dec. 22, 2015, which is hereby incorporated by reference in its entirety.

### BACKGROUND OF THE INVENTION

The use of concentrated protein sources is desirable in aquaculture diets in order to address nutritional needs in a metabolizable nutrient dense package. This is especially true in organisms with a simple alimentary canal and rapid transit of feedstuffs though the gastrointestinal system. Shrimp exhibit such a system, and a high protein low carbohydrate diet is advantageous for shrimp. Additionally, shrimp species may have the capabilities to utilize lactic acid or other organic acids to improve enzymatic digestibility and balance gut pH. Additionally, decreasing the luminal pH in shrimp through the addition of lactic acid may improve shrimp health, survivability, and productivity.

### SUMMARY OF THE INVENTION

Described herein are fermented vegetable protein (FVP) compositions for use in animal feed, and methods of producing such compositions. In one aspect, the present invention relates to feed ingredients, feed products containing such ingredients, and feed diets containing such products or ingredients. In one aspect, the present invention relates to a feed ingredient that is a high in protein and organic acid. Accordingly, the feed ingredient or product of the present invention can include one or more organic acids and is rich in amino acids. In one aspect, the feed ingredient or product can be produced using a fermentation process, for example through the fermentation of a vegetable mill stream, resulting in a fermented vegetable protein. In one aspect, the present invention relates to a feed ingredient, feed product, or feed diet which can lower the occurrence of bacterial infection in an animal. Accordingly, the present invention also includes methods for feeding an animal, and/or methods for reducing or preventing the spread of bacterial infections in an animal. The compositions and methods described herein are particularly useful for aquaculture, such as for farmed shrimp. However, the compositions and methods are not limited to shrimp and can be used for feeding any animal, including, but not limited to, poultry and swine.

In one aspect, an animal feed ingredient is described, comprising: one or more organic acids, one or more proteins, phosphorus, and less than 0.6 wt % phytic acid. The one or more organic acids can be selected from the group consisting of lactic acid, formic acid, propionic acid, fumaric acid, citric acid, butyric acid, gluconic acid, itaconic acid, pyruvic acid, salts thereof, and any combination of these organic acids or salts thereof. The one or more organic acids can be present in an amount suitable for reducing the gastric pH of an animal. In some embodiments, the one or more organic acids are present in an amount of about 45 to 50 wt % dry basis. In one aspect, the one or more proteins are derived from any vegetable source, including, but not limited to, any stream from a grain milling process or grain fermentation process. In some embodiments, the one or more proteins can include corn protein. The one or more proteins can be present in an amount of about 25 to 35 wt % dry basis.

In some embodiments, the feed ingredient can include 4.0 to 6.0 wt % free phosphate on dry basis and/or 38 to 43 wt % lactic acid on dry basis. In some embodiments, the feed ingredient is less than 2 wt % of sugars on dry basis. In some embodiments, the feed ingredient is at least 40% dry solids.

In one aspect, an animal feed product is described, comprising one or more of the feed ingredients described herein. In some embodiments, the feed product further includes a vegetable protein concentrate, such as corn protein concentrate. In some embodiments, the feed product further includes corn gluten meal. In some embodiments, the phytic acid content of the feed product is less than 0.6 wt % dry basis. In some embodiments, the feed product has an organic acid content of about 8.0 to 9.0 wt % dry basis. In some embodiments, the feed product comprises 72 to 76 wt % protein dry basis; 3.0 to 3.6 wt % lysine dry basis; 6 to 8 wt % lactic acid dry basis; and/or 4.0 to 6.0 wt % free phosphate on dry basis. In some embodiments, the feed product has less than 2 wt % of sugars on dry basis. In some embodiments, the feed product has a moisture content of less than 9%.

In one aspect, an animal feed diet is described that comprises an animal feed ingredient and/or animal feed product of the present invention. In some embodiments, the animal feed diet comprises 2 to 24% of a feed product of the present invention. In some embodiments, the animal feed diet comprises 10 to 14% of a feed product of the present invention. In some embodiments, the feed diet further comprises a fat.

In one aspect, the animal feed ingredients, animal feed products, or animal feed diets of the present invention are suitable for feeding an aquatic animal. In some embodiments, the aquatic animal is a shrimp.

In one aspect, a process for producing an animal feed ingredient is described, comprising: providing a fermentation medium comprising one or more proteins and one or more sugars; fermenting the fermentation medium to produce a fermentation product, such as one or more organic acids; optionally adjusting the pH of the fermentation medium during fermentation; optionally adjusting the temperature of the fermentation medium during fermentation, optionally treating the fermentation medium to reduce an anti-nutritional factor (ANF), and concentrating the fermentation medium to produce an animal feed ingredient, wherein the animal feed ingredient comprises one or more organic acids and one or more proteins.

In some embodiments, the concentration of solids in the fermentation medium is about 9 to 14% prior to fermentation. In some embodiments, the one or more organic acids are selected from the group consisting of lactic acid, formic acid, propionic acid, fumaric acid, citric acid, butyric acid, gluconic acid, itaconic acid, pyruvic acid, salts thereof, and any combination of these organic acids or salts thereof.

In some embodiments, the process further comprises adding a feed component to the fermentation medium. In some embodiments, the feed component is an intermediate mill stream or an intermediate fermentation stream. In some embodiments, the feed component comprises an amino acid. In some embodiments, the feed component comprises lysine. In some embodiments, the fermentation medium is a corn mill stream. In some embodiments, the process further includes an evaporation step. In some embodiments, the evaporation step increases concentration of solids in the animal feed ingredient or fermentation medium to about 45 to 65 wt %.

In some embodiments, the process further comprising combining the animal feed ingredient with a protein concentrate to form an animal feed product. In some embodiments, the protein concentrate comprises corn protein.

In some embodiments, the process can include a drying step. In one such embodiment, the moisture content of the animal feed ingredient or animal feed product is less than 9% after the drying step. In some embodiments, the ANF reduction step comprises a phtyase treatment. In some embodiments, the phtyase treatment increases the bioavailable phosphorus content of the animal feed product.

In some embodiments, the fermentation medium is fermented using a microorganism endogenous to the fermentation medium. In some embodiments, the process includes the step of inoculating the fermentation medium with a microorganism. In one such embodiment, the fermentation medium is sterilized or pasteurized prior to inoculating. In some embodiments, the microorganism is of a genus selected from the group consisting of Lactobacillus, Leuconostoc, Acetobacter, Aspergillus, Bacillus, Brevibacterium, Clostridium, Corynebacterium, Micrococcus, Penicillium, Rhizopus, and Saccharomyces.

In one aspect, a method for treating or preventing a bacterial infection in an animal is described that comprises administering any of the animal feed ingredient, animal feed products, or animal feed diets of the present invention. In some embodiments, the animal is a shrimp. In some embodiments, the bacterial infection is early mortality syndrome (EMS). In some embodiments, the luminal pH of the animal is reduced after administration of the animal feed composition, animal feed ingredient, or animal feed product.

### BRIEF DESCRIPTION OF THE DRAWINGS

The following detailed description of the invention will be better understood when read in conjunction with the appended drawings. It should be understood, however, that the invention is not limited to the precise arrangements and instrumentalities of the embodiments shown in the drawings.

FIG. 1 is a diagram of an exemplary embodiment of a process for producing an animal feed ingredient, product, and diet.

FIG. 2 is a graph showing lactic acid production and sugar depletion during an exemplary process for producing an animal feed ingredient.

FIG. 3 is a graph showing phosphate release and phytate reduction during an exemplary process for producing an animal feed ingredient.

FIG. 4 is a graph and corresponding table showing the amino acid profile for feed ingredients and products, including an exemplary feed ingredient (FVP-1) and feed product (FVP-FP) produced according to a process described herein (bars left to right: FVP-1, Empyreal 75, FVP-FP).

FIG. 5, comprising FIGS. 5A and 5B, is a plot showing the pH of different feed materials in contact with a water system.

FIG. 6, comprising FIGS. 6A and 6B, is a plot showing pH buffering of different feed materials in contact with an acidic system (pH 1.9 and 2.5).

FIG. 7 is a graph showing the amino acid profile of various feed diets, including an exemplary embodiment of a feed diet including a feed ingredient of the present invention (FVP diet) (bars left to right: Empyreal 75 diet, FVP-FP diet, E75+OrgAc 2.2 diet, E75+OrgAc 7.4 diet).

FIG. 8, comprising FIGS. 8A and 8B, is a set of graphs showing % weight gain, feed conversion ratio (FCR), mean final weight, and growth per week data resulting from a feed study of various feed diets.

### DETAILED DESCRIPTION

It is to be understood that the figures and descriptions of the present invention provided herein have been simplified to illustrate elements that are relevant for a clear understanding of the present invention, while eliminating other elements found in the related field(s) of art. Those of ordinary skill in the art would recognize that other elements or steps may be desirable or required in implementing the present invention. However, because such elements or steps are well known in the art or do not facilitate a better understanding of the present invention, a discussion of such elements or steps is not provided herein.

Unless defined otherwise, all technical and scientific terms used herein have the same meaning as commonly understood by one of ordinary skill in the art to which this invention belongs. As used herein, each of the following terms has the meaning associated with it as defined in this section.

As used herein, the term “fermented vegetable protein” (FVP) refers to a mixture of protein and one or more fermentation products obtained via fermentation of a process stream associated with processing vegetable matter. In a preferred embodiment, the fermentation product is an organic acid. The process stream that is fermented can be any stream associated with a vegetable milling process. Other suitable process streams can include any waste or byproduct streams from vegetable processing. For the purposes of this disclosure, vegetable matter can include any materials associated with fruits, vegetables, grains, or other plants that are suitable for use as food for animals, or that can be converted into a material suitable for use as food for animals. Accordingly, other terms can be used herein to refer to a fermented vegetable protein, for example “fermented grain protein” or “fermented corn protein.” Further, the terms “feed ingredient,” “feed product,” and “feed diet” as used herein refer to compositions that include a fermented vegetable protein according to the present invention, unless otherwise noted.

Throughout this disclosure, various aspects of the invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 7 should be considered to have specifically disclosed subranges such as from 1 to 3, from 1 to 4, from 1 to 6, from 2 to 5, from 3 to 5, etc., as well as individual numbers within that range, for example, 1, 2, 3, 3.6, 4, 5, 5.8, 6, 7, and any whole and partial increments in between. This applies regardless of the breadth of the range.

### Animal Feed Compositions

The present invention relates to animal feed ingredients, animal feed products, and animal feed diets including such ingredients and products. The feed ingredients and products are particularly useful in aquaculture applications, such as for feeding shrimp. However, the feed ingredients and products can be used for other animals, such as poultry and swine. The feed ingredient includes at least one organic acid, generally in the form of a mixture of its acid and conjugate base and/or salt, and protein. In some embodiments, the feed ingredient can include other nutrients or components, for example, but not limited to phosphates, peptides, free amino nitrogen (FAN), soluble proteins, soluble carbohydrates, vitamins, minerals, cofactors, and non-protein nitrogen. The feed product is a composition that includes the feed ingredient and other components, and that is typically manufactured to be a relatively homogenous and substantially dry material. The feed diet is a composition that includes the feed product and any other components that are needed to supplement or complete the dietary needs of an animal.

### Feed Ingredients

The feed ingredient of the present invention includes a fermented vegetable protein composition. In some embodiments, the feed ingredient is a fermented corn protein. However, vegetable matter other than corn can be used to make the feed ingredient, either instead of or in addition to corn.

In one embodiment, the organic acid of the feed ingredient is lactic acid, in its lactate form, preferably a high quality, bioavailable source of lactic acid. In some embodiments, the feed ingredient can include another organic acid instead of, or in addition to, lactic acid. Non-limiting examples of organic acids useful for the feed ingredients described herein include formic acid, citric acid, acetic acid, succinic acid, malic acid, fumaric acid, propionic acid, gluconic acid, itaconic acid, pyruvic acid, and butyric acid. As would be understood by a person skilled in the art, other organic acids not specifically listed herein can be used for the feed ingredients of the present invention. In some embodiments, the feed ingredient can include a fermentation product other than an organic acid.

In a preferred embodiment, the one or more organic acids of the feed ingredient are organic acids that can be produced via fermentation and converted into their salt form, for example by caustic addition. As used herein, the term “organic acid” can refer to the acid in either its un-dissociated or dissociated form. Accordingly, the feed ingredient of the present invention can include an organic acid, the conjugate base of the organic acid, and/or a salt of the organic acid. The salt of the organic acid is preferably a sodium, potassium, or calcium salt or mixture thereof. In some embodiments, the total organic acid content of the feed ingredient is at least 45% dry basis (d.b.). In some embodiments, the organic acid content of the feed ingredient is in the range of about 35 to 60%, 40 to 55%, 45 to 50% d.b. In some embodiments, the lactic acid content, or the content of another single organic acid, is at least 38% d.b. In other such embodiments, the lactic acid content is in the range of about 30 to 50%, 35 to 45%, or 38 to 43% d.b.

The feed ingredient also includes one or more proteins and/or components derived from proteins, such as free amino acids and low molecular weight peptides (e.g., peptides having a molecular weight less than 1000 Da).

The feed ingredient can be made by fermenting light steep water or some other stream associated with a corn milling process. Accordingly, in one embodiment, the ingredient includes corn protein and/or has an amino acid profile that is consistent with corn protein, as would be understood by a person skilled in the art. In some embodiments, the feed ingredient has a protein content in the range of about 20 to 40%, 25 to 35%, or 28 to 31% dry basis. In some embodiments, the feed ingredient includes a lysine content of about 2 to 5% or 2.5 to 3.5% d.b., which generally correlates to the lower lysine content typically found in corn protein. However, in some embodiments, lysine can be added to increase the lysine content of the feed ingredient. For example, in some embodiments, the lysine content of the feed ingredient can be in the range of about 10 to 15% or 11 to 13% d.b.

In some embodiments, other components can be added to and/or combined with the feed ingredient, instead of, or in addition to lysine. For example, components that would not typically be found in the fermentation medium or in the fermentation product can be added to improve the nutritional value of the feed ingredient. Further, as would be understood by a person skilled in the art, the addition of other components to the feed ingredient will result in a change of the overall protein and/or organic acid concentration of the feed ingredient. For example, a feed ingredient containing a higher lysine content of 11 to 13% can have a protein concentration of 37 to 39%, a total organic acid content of 39 to 42%, and a lactic acid content of 32 to 36% d.b.

The feed ingredient is preferably low in anti-nutritional factors (ANFs). For example, corn mill streams are known to include phytic acid. In one embodiment, phytase can be added during processing of the feed ingredient to hydrolyze phytic acid. Accordingly, the feed ingredient can be low in phytic acid, for example, having less than 1%, less than 0.6%, less than 0.5%, less than 0.4%, less than 0.3%, less than 0.2%, or less than 0.1% phytic acid on a dry basis.

Further, phytase treatment of a corn mill stream or a corn protein concentrate slurry can result in freeing phosphorous bound to the phytic acid ring. Therefore, the feed ingredient can include phosphorous, in free phosphate form, for example, having at least 0.5%, 1%, 1.5%, or 2%, 3%, 4%, 5%, 6%, or more, on d.b. In some embodiments, the feed ingredient contains 1 to 7%, 2 to 6%, or 4 to 6% free phosphate on a dry basis.

As described below, the feed ingredient can be produced through fermentation of any vegetable mill stream, for example the fermentation of light steep water. Accordingly, the feed ingredient can be in a liquid form, for example a liquid including 9 to 14 wt % soluble and/or solid material on a dry basis. In some embodiments, producing the feed ingredient can include a concentration or evaporation step, which can result in a concentrated liquid or syrup, for example a syrup including 40 to 75%, more preferably 45-52 wt % solids on a dry basis. In one embodiment, the feed ingredient is dried to reduce the moisture content to less than 10 wt %.

### Feed Products

The present invention also relates to feed products that include the feed ingredient described herein. In a preferred embodiment, the feed product includes other components in addition to the feed ingredient of the present invention. For example, the feed ingredient can be formulated with other feed ingredients or additives to change the amino acid profile, or to include other nutritional components. In one embodiment, the feed ingredient is blended or otherwise combined with other components prior to drying. In a preferred embodiment, the feed ingredient is blended and co-dried with other components to produce a relatively homogenous feed product. In one such embodiment, the feed ingredient is blended and co-dried with a corn protein concentrate, e.g., Empyreal® corn protein concentrate. In some embodiments, the feed product can be a powder, granule, pellet, or other dry form, as would be understood by a person skilled in the art, for example a dry material having less than 10, less than 9, less than 8, less than 7, less than 6, less than 5, less than 4, less than 3, less than 2, or less than 1 wt % moisture.

In some embodiments, the total organic acid content of the feed product is greater than 8% dry basis. In some embodiments, the total organic acid content of the feed product is in the range of about 6 to 11%, 7 to 10%, 7.5 to 9.5%, or 8 to 9% d.b. In some embodiments, the lactic acid content of the feed product is in the range of about 5 to 9%, 6 to 8%, or 6.5 to 7.5% d.b.

In some embodiments, the feed product has a total protein content in the range of about 60 to 85%, 65 to 80%, 70 to 78%, 72 to 76%, or 73 to 75% dry basis. In some embodiments, the lysine content of the feed product is in the range of about 2 to 5%, 3 to 4%, or 3.1 to 3.6% d.b.

It is contemplated herein that the feed ingredients and feed products described herein can be processed such that the various components are combined to be a substantially homogenous material. In some embodiments, the various components and materials of the feed ingredients or feed products of the present invention can be bound together with the fermented vegetable protein, and not just merely mixed together. Accordingly, as would be understood by a person skilled in the art, the fermented vegetable protein can be more advantageous for use as an animal feed due to this binding and homogeneity, as compared with currently available feed materials. In one aspect, the fermented vegetable protein can be absorbed or digested more readily by the animal than other feed materials.

### Feed Diets

The present invention also relates to animal feed diets. The animal feed diets include the feed ingredients or feed products described herein in combination with one or more other feed ingredients or feed products. Such combinations can provide a complete and balanced diet for an animal. In one embodiment, the animal feed diet is a shrimp diet. In some embodiments, the feed product includes about 2 to 24 wt % of the feed product described herein.

Table 1 shows the percent inclusion of various materials in selected shrimp diets. The amounts of various ingredients and components are shown for a reference diet, i.e., a currently available commercial feed diet, and exemplary feed diets of the present invention, i.e., feed diets that include 6%, 12%, or 20% FVP-FP. Fixed microingredients are ingredients having identical amounts in each feed diet. The amounts of soybean meal and anchovy fishmeal in each diet are adjusted to account for increasing inclusion of FVP-FP.

Notably, the feed diets that include FVP-FP have higher protein and less ash than the reference diet, but include less fishmeal. Fishmeal is one of the most expensive ingredients in shrimp feed diets. Therefore, the feed diets of the present invention can be significantly cheaper than currently available diets. Further, the feed diets containing FVP-FP have amino acid profiles comparable to the reference diet, with only a minimal reduction in lysine and threonine.

TABLE 1
Selected Shrimp Diets

| | Inclusion (%) | | | |
|---|---|---|---|---|
| | Reference | 6% | 12% | 20% |
| | diet | FVP-FP | FVP-FP | FVP-FP |
| Macroingredients- VARIABLE | | | | |
| FVP-FP | — | 6.00 | 12.00 | 20.00 |
| soybean meal solvent 44% CP | 29.62 | 27.01 | 24.27 | 20.43 |
| Wheat Hard Grain | 28.00 | 28.00 | 28.00 | 28.00 |
| fishmeal anchovy | 11.37 | 7.99 | 4.62 | 0.14 |
| fishmeal white | 10.00 | 10.00 | 10.00 | 10.00 |
| rice broken brewers | 5.00 | 5.00 | 5.00 | 5.00 |
| Barley whole grain ground | 4.50 | 4.50 | 4.50 | 4.50 |
| fish oil menhaden | 4.00 | 4.00 | 4.00 | 4.00 |
| Palm Kernel Meal | 1.50 | 1.50 | 1.50 | 1.50 |
| Microingredients- VARIABLE | | | | |
| DL Methionine | 0.14 | 0.13 | 0.11 | 0.10 |
| Lysine | 0.00 | 0.00 | 0.00 | 0.02 |
| Threonine | 0.00 | 0.00 | 0.13 | 0.32 |
| Microingredients - FIXED | | | | |
| Fish Hydrolisate - Aquativ | 1.00 | 1.00 | 1.00 | 1.00 |
| Lecithin Soy | 1.00 | 1.00 | 1.00 | 1.00 |
| squid meal | 1.00 | 1.00 | 1.00 | 1.00 |
| Calcium Carbonate | 0.50 | 0.50 | 0.50 | 0.50 |
| potassium formate | 0.50 | 0.50 | 0.50 | 0.50 |
| sodium chloride | 0.50 | 0.50 | 0.50 | 0.50 |
| binder | 0.40 | 0.40 | 0.40 | 0.40 |
| vitamin premix-L. vannamei | 0.35 | 0.35 | 0.35 | 0.35 |
| mold inhibitor | 0.30 | 0.30 | 0.30 | 0.30 |
| Choline chloride | 0.08 | 0.08 | 0.08 | 0.08 |
| enzymes blend | 0.07 | 0.07 | 0.07 | 0.07 |
| Vitamin C | 0.07 | 0.07 | 0.07 | 0.07 |
| K2SO Potassium sulfate/potash | 0.05 | 0.05 | 0.05 | 0.05 |
| Cholesterol | 0.03 | 0.03 | 0.03 | 0.03 |
| antioxidant | 0.02 | 0.02 | 0.02 | 0.02 |
| Nutrientional Profile | % | % | % | % |
| Crude Protein | 33.10 | 33.93 | 34.83 | 36.00 |
| Crude Fat | 7.00 | 7.00 | 7.00 | 7.00 |
| Crude Fiber | 4.12 | 3.96 | 3.80 | 3.56 |
| Ash | 7.63 | 7.07 | 6.50 | 5.73 |
| Lysine | 1.70 | 1.64 | 1.57 | 1.50 |
| Methionine | 0.70 | 0.70 | 0.70 | 0.70 |
| Threonine | 1.05 | 0.91 | 0.90 | 0.90 |
| Cost (USD/metric ton) | 411.57 | 400.37 | 390.53 | 377.91 |
| Savings compared to | — | 2.72 | 5.11 | 8.18 |
| reference (%) | | | | |

### Animal Feed Manufacturing Methods

The present invention also relates to processes for making feed ingredients and feed products. The feed ingredients can be made by processing mill streams, for example by fermenting a mill soluble stream, such as light steep water (LSW) to yield a fermented vegetable protein. The feed products can be made by blending and/or co-drying the feed ingredients with other components.

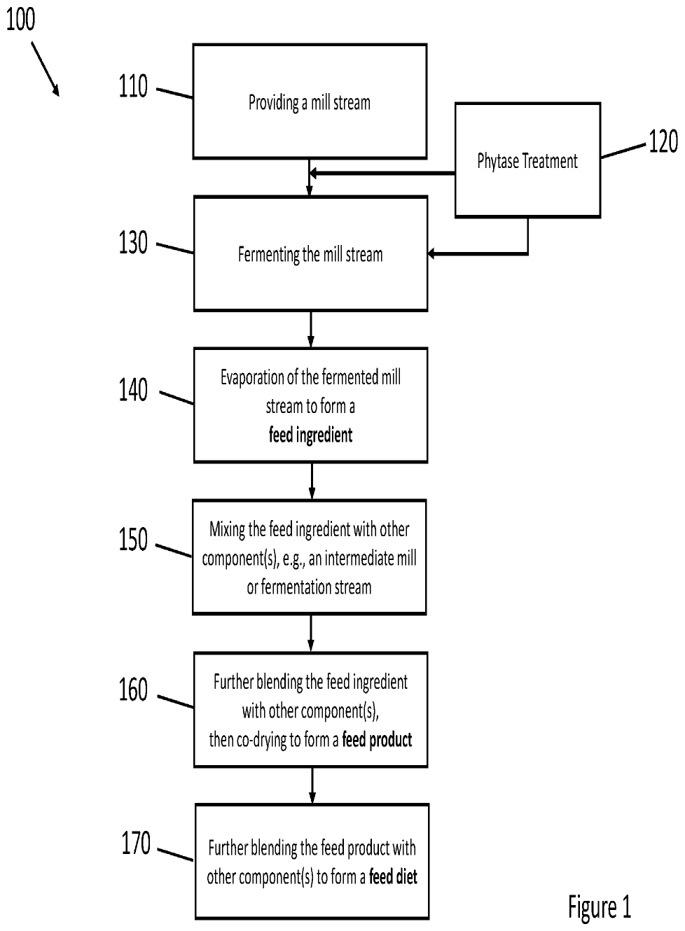

Referring now to FIG. 1, a diagram of an exemplary process 100 for making an animal feed ingredient, feed product, and/or a feed diet is shown. First, a mill stream such as LSW is provided as a fermentation medium (110). However, the mill stream can be any suitable fermentation medium containing a fermentable substrate, as would be understood by a person skilled in the art. In one aspect, the mill stream can also be a byproduct stream from a milling or fermentation process that includes a fermentable substrate. Examples of suitable mill streams, include, but are not limited to any wet stream from a process used to mill corn, wheat, sorghum, cassava, or any other grain, pulse, or vegetable material. An exemplary material useful as the fermentation medium in process 100 is light steep water, which is high in protein and sugar, but also includes a significant amount of phytate. In other embodiments, materials such as gluten mill water (GMW) and filtrate streams from corn protein concentrate processing can be used. Slurries of dry grind streams are also suitable for process 100. It is contemplated herein that the mill stream includes a dissolved fermentation substrate, but the mill stream can include insoluble material instead of or in addition to the soluble material. Further, process 100 can include one or more steps associated with preparing the mill stream for use as a fermentation medium, such as combining dry grind materials with water, diluting the mill stream provided, adding additional fermentation substrate, such as dextrose, to the mill stream, or performing an evaporation step on the mill stream provided.

Once the mill stream is provided (110), the mill stream can optionally be treated with phytase (120) to hydrolyze phytic acid. In some embodiments, the mill stream can be treated with other enzymes instead of, or in addition to, phytase. The mill stream is then fermented (130). In some embodiments, the phytase treatment can be performed during or after fermentation step 130, instead of or in addition to a pre-fermentation treatment. The fermentation step 130 increases the organic acid concentration of the mill stream. In one embodiment, the organic acid is lactic acid. In one embodiment, a base such as sodium hydroxide can optionally be added to convert some or all of the organic acid to a salt form. The mill stream and/or fermented mill stream can optionally be treated to reduce or eliminate one or more anti-nutritional factors other than phytic acid.

The fermented mill stream is then concentrated, for example by evaporation through applying heat and/or vacuum, to form a fermented vegetable protein (FVP) syrup (140), i.e., a feed ingredient. The FVP syrup is then blended with other components, for example an intermediate mill stream or an intermediate fermentation stream (150). In one embodiment, the component blended with the FVP syrup has a high lysine content. The blended syrup is then blended and co-dried with one or more other components, such as a high-protein corn gluten meal or corn protein concentrate (e.g., Empyreal® 75), to form a feed product (160). In one embodiment, the feed product of step 160 can be further blended with, or added to, other feed ingredients or products to form an animal feed diet (170).

Referring now to Table 2 below, exemplary composition ranges for various process streams, feed ingredients, and feed products are shown. In this example, light steep water (200) is the mill stream that is fermented, which increases the organic acid content (210). The post-fermentation LSW (210) is then evaporated to generate a fermented vegetable protein syrup having a higher solids content (FVP-1, 220). A component high in lysine can then be added to increase the lysine content of the FVP-1 feed ingredient (FVP-2, 230). A corn protein concentrate (CPC, 240) can then be combined with the FVP-2 and co-dried to generate an exemplary embodiment of the feed product of the present invention, FVP-FP (250).

TABLE 2
Composition of various feed-related materials

| | | | | % PO4 | | % Protein | | % Lysine | | % OrgAc | | % LacAc | |
|---|---|---|---|---|---|---|---|---|---|---|---|---|---|
| | | | Density | (db) | | (db) | | (db) | | (db) | | (db) | |
| | | % DS | (kg/L) | Min | Max | Min | Max | Min | Max | Min | Max | Min | Max |
| 200 | LSW | 12.5% | 1.05 | 1.5 | 1.9 | 37.1 | 39.1 | 4.0 | 4.8 | 20.3 | 25.4 | 12.7 | 18.6 |
| 210 | Post-Ferm | 14.8% | 1.07 | 4.4 | 5.7 | 28.7 | 30.4 | 2.7 | 3.4 | 45.6 | 48.4 | 38.4 | 42.7 |
| | LSW | | | | | | | | | | | | |
| 220 | FVP-1 | 48.8% | 1.25 | 4.4 | 5.7 | 28.7 | 30.4 | 2.7 | 3.4 | 45.6 | 48.4 | 38.4 | 42.7 |
| 230 | FVP-2 | 49.7% | 1.26 | 3.7 | 4.8 | 37.2 | 38.6 | 11.0 | 13.0 | 39.0 | 42.1 | 32.4 | 36.2 |
| 240 | CPC | 91.0% | — | 0.05 | 0.09 | 82.4 | 83.5 | 1.2 | 1.4 | 0.8 | 0.9 | 0.7 | 0.8 |
| 250 | FVP-FP | 92.0% | — | 0.74 | 0.99 | 72.9 | 74.1 | 3.3 | 3.9 | 8.8 | 9.5 | 7.3 | 8.2 |

“FVP1” and “FVP-2”: exemplary embodiments of feed ingredients according to the present invention;
“FVP-FP”: an exemplary embodiment of a feed product of the present invention;
“OrgAc” = organic acids;
“LacAc” = Lactic Acid

Process 100 of the present invention is not limited to the embodiments shown in FIG. 1 or Table 2, however, and can include other steps, can include steps in a different order, or can utilize other materials, as would be understood by a person skilled in the art.

In one aspect, the fermentation conditions can be adjusted to optimize the rate of fermentation of the fermentation substrate to the desired fermentation product, for example lactic acid. In one embodiment, the temperature during the fermentation step can be held within a range that promotes a higher rate of formation for the desired product. For lactic acid as a fermentation product, the temperature range can be held in the range of about 47-55° C. Other conditions can also be adjusted, or other steps performed during fermentation to optimize the formation of the desired product. For example, in one embodiment, dextrose can be added during the fermentation, for example to perform a fed-batch type fermentation. In another embodiment, the pH can be adjusted during fermentation, for example by adding sodium hydroxide, lime slurry, or some other material. In some embodiments, the pH during fermentation is maintained in the range of about 4.3 to 6.0.

In some embodiments, the fermentation process is run for a predetermined amount of time, for example 40 to 50 hours. In other embodiments, the fermentation process can be run for more than 50 hours or less than 40 hours. As would be understood by a person skilled in the art, shorter fermentation process can result in unfermented sugars remaining in the feed ingredient. In other embodiments, the fermentation process can be run until most or all of the fermentation substrate is consumed, or until the formation of fermentation product has ceased. In one aspect, the preferred fermentation process conditions for fermenting light steep water are shown in Table 3. However, the fermentation process conditions are not limited to any specific values or ranges recited herein.

TABLE 3
Exemplary process conditions for a process
for producing an animal feed ingredient

| | Min | Max |
|---|---|---|
| 1. Time of Fermentation (hrs) | 44 | 48 |
| 2. pH (averaged) | 4.3 | 5.5 |
| 3. Temperature (averaged, ° F.) | 119 | 122 |

| | |
|---|---|
| 4. Phytase addition | 0.1% on dry basis |

| | | |
|---|---|---|
| 5. Dextrose addition (g/L) | 42 | 55 |
| 6. Lactic Production (g/L/hr) | 0.64 | 0.92 |

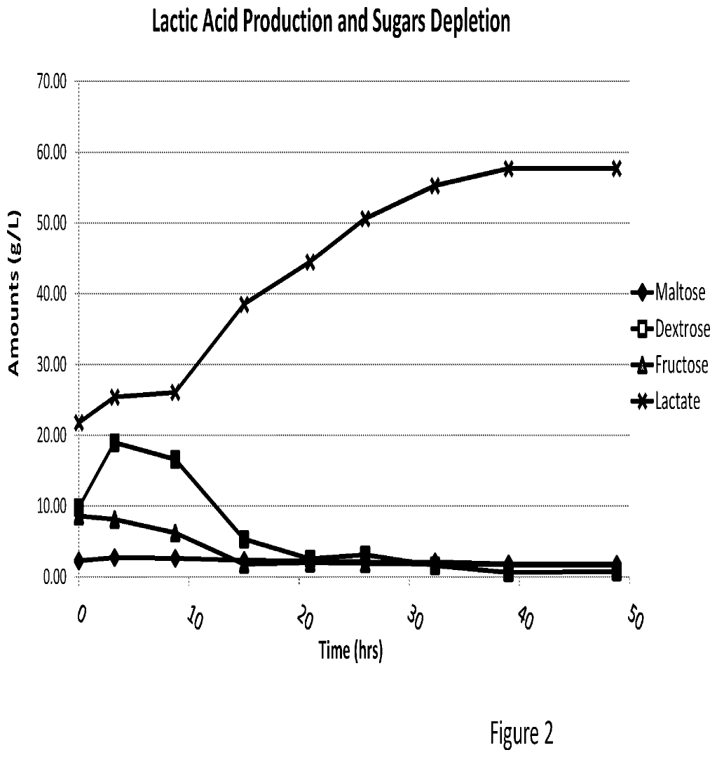

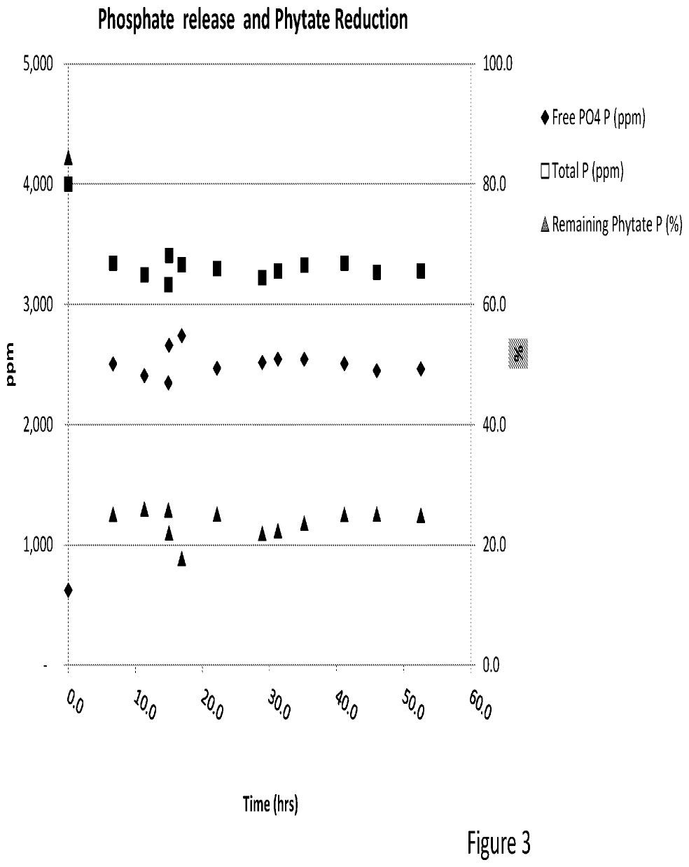

FIGS. 2 and 3 show data for an exemplary fermentation step. FIG. 2 shows the depletion of sugar and a corresponding increase in lactate during fermentation of a mill stream. FIG. 3 shows the effects of phytase treatment on the mill stream, i.e., a decrease in total phosphorous and phytate and corresponding increase in free phosphate in the mill stream.

In one embodiment, LSW is fermented. Light steep water is a byproduct of corn wet-milling that typically contains about 9 to 14% mill solubles or solids by weight. The solubles are generally sugars, proteins, small peptides, free amino acids, vitamins, and minerals, but can include other nutrients or compounds, as would be understood by a person skilled in the art. In some embodiments, the fermentation step can be performed using naturally occurring microorganisms already present in the mill stream, for example lactobacilli bacteria typically found in LSW.

In other embodiments, a microorganism other than naturally occurring lactobacilli bacteria can be used, for example, a different type of bacteria, a yeast, or a fungus can be added to the fermentation process. In such an embodiment, the mill stream can be pasteurized or sterilized to reduce or eliminate any endogenous microorganisms. As would be understood by a person skilled in the art, the mill stream can then be adjusted to the desired fermentation temperature and inoculated with one or more microorganisms. Exemplary microorganisms include, but are not limited to: lactic acid bacteria, for example from homofermentative and heterofermentative Lactobacillus and Leuconostoc; Acetobacter; Aspergillus; Bacillus; Brevibacterium; Clostridium; Corynebacterium; Micrococcus; Penicillium; Rhizopus; and Saccharomyces and other yeasts.

Accordingly, the fermentation product can include a compound other than lactic acid, for example any other organic acid. In some embodiments, a mixture of different bacteria, yeast, and/or fungi can be used, for example to provide a mixture of different fermentation products.

As described above, the process can include one or more steps directed to decreasing or eliminating one or more anti-nutritional factors. In some embodiments, the process can include treatment with one or more enzymes. For example, the process can include a phytase treatment step, where an appropriate amount of phytase is used to release bound phosphorus from phytate, thereby creating a bioavailable phosphate form. In some embodiments, the process can include a treatment step to reduce or eliminate the anti-nutrient sulfur dioxide, for example treating a mill stream with hydrogen peroxide.

In one embodiment, the process includes an evaporation step. The evaporation step is used to increase the concentration of dry solids. For example, in one embodiment, the weight percent dry solids of the process stream can be increased to about 40 to 75% solids, 45 to 65% solids, or 47 to 52% solids. The evaporation step results in an FVP syrup that can be further processed as described below. In one embodiment, the process can include an evaporation step prior to the fermentation step, instead of or in addition to the post-fermentation evaporation step. In such an embodiment, the evaporation step increases the soluble concentration of the process stream to about 40 wt % solids or greater on a dry basis prior to the fermentation step. For example, the fermentation step can be performed on corn steep liquor (CSL). CSL is also referred to as heavy steep water, and is generally formed by evaporating light steep water. As would be understood by a person skilled in the art, performing an evaporation step on the mill stream prior to the fermentation step can result in the decrease or elimination of the native microorganism population. Accordingly, the concentrated mill stream after an evaporation step may require inoculation with a suitable microorganism prior to fermentation.

The process can also include a drying step. The drying step can be performed at any point in the process after a fermented vegetable protein is formed. In one embodiment, the process stream can be co-dried with other streams to add other ingredients to the feed ingredient or product. For example, the process stream can be co-dried with a protein stream such as a corn protein isolate; a dewatered cake such as corn gluten meal; Empyreal® 75 corn protein concentrate; distillers solids; and/or any other suitable stream. Co-drying is particularly useful in the manufacturing process because it can improve the overall homogeneity of the feed ingredient or product in comparison to merely mixing additives into a dried FVP material.

The process can also include one or more blending or mixing steps. A blending step can be performed after drying the feed ingredient or product of the present invention, or it can be performed on any one of the wet process streams. As previously described, lysine can be blended with the FVP syrup feed ingredient in some embodiments. In some embodiments, the FVP syrup feed ingredient is blended and co-dried with a corn protein concentrate to form a feed product. Any suitable feed component can be combined with the FVP material. For example, any intermediate stream from a vegetable milling or fermentation process can be used as a feed component to be combined with the FVP material, including byproduct streams. In preferred embodiments, the feed components are combined with the FVP material prior to concentrating and/or drying the FVP material to improve the homogeneity of the feed ingredient or product.

An exemplary blending and co-drying process is described as follows: an FVP syrup having approximately 40 to 75% dry solids is applied to a second feed ingredient via an operation, for example spraying or another type of operation, to achieve relatively even distribution on the second ingredient. The second feed ingredient can be an FVP material according to the present invention, or it can be any other material suitable for animal feed. The FVP syrup can be applied at a predetermined rate, for example one to sixteen gallons per minute, via pump and nozzle to a liquid corn protein concentrate (5 to 20% DS) flowing at 200 to 400 gallons per minute. The two feed ingredient stream flow rates can be manipulated to achieve a desired application of FVP as a dry solids component of the final feed product, and to target specific levels of organic acid and/or amino acid levels in the feed product. The combined process stream can then be co-dried to achieve a desired moisture content of 2 to 8%. In one embodiment, the use of a flash drier with a temperature range of 200 to 270° F. for 8 to 12 minutes duration can achieve the desired moisture content. However, the blending and co-drying process steps of the present invention are not meant to be limited by the description above and can include any suitable operations, equipment, or conditions, as would be understood by a person skilled in the art.

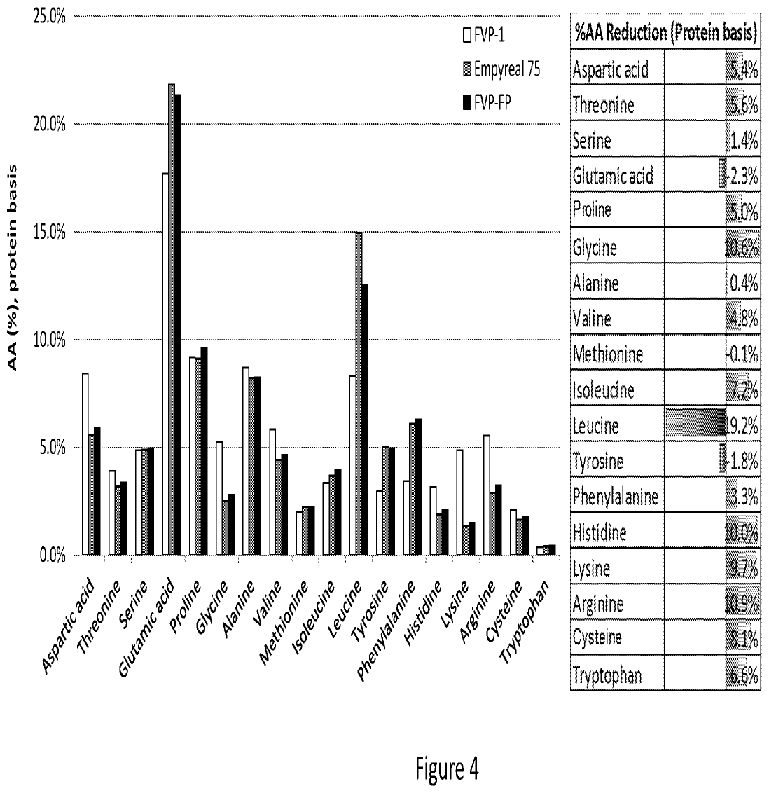

The amino acid profiles for a feed ingredient (FVP), corn protein concentrate (Empyreal), and a feed product (Empyreal-FVP) are shown in FIG. 4.

### Methods of Feeding

Described herein are feed ingredients and products that can be used to provide a complete diet, or at least supplement a complete diet, for an animal. In addition, described herein are feed ingredients and products that can reduce the spread of early mortality syndrome (EMS) in farmed shrimp. Early mortality syndrome (EMS), also known as acute hepatopancreatic necrosis syndrome (AHPNS) is a disease affecting shrimp that is generally believed to be caused by a bacterial infection. EMS can quickly spread among farmed shrimp populations, causing mortality rates of up to 90% within 30 days. Therefore, the prevention or mitigation of the occurrence of EMS in shrimp farms is desirable.

Accordingly, the present invention further relates to a methods of feeding an animal, and also a method for treating or preventing a bacterial infection in an animal. In one embodiment, the animal is a shrimp, but the method may be suitable for use in other animals. The feed ingredient, product, or diet described herein can change the pH in the gut or lumen to provide resistance to bacteria. In one embodiment, the pH of the feed ingredient or product can be 4.5 or less, for example in the range of 4.2-4.5.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather should be construed to encompass any and all variations which become evident as a result of the teaching provided herein.

### Example 1: FVP Buffering Capacity

The lactic acid concentrations in water of different feed systems and the correlation to decreases in pH were measured over time. While not wishing to be bound by theory, it is believed that some organic acid(s) may be bound to protein and/or physically entrapped in the ingredient matrix in some embodiments of the feed ingredient of the present invention, and is released over time. This mechanism may be biologically useful as a timed release technology in the target species, allowing a buffering over time as opposed to acute buffering of the animal's gut.

Four feed compositions were studied: 1) FVP syrup (an exemplary embodiment of a feed ingredient of the present invention); 2) An FVP feed product (an exemplary embodiment of a feed product of the present invention, that includes FVP and corn protein concentrate blended and bound together); 3) Empyreal 75 (corn protein concentrate, “E-75”); and 4) Empyreal-LA (a corn protein concentrate combined with lactic acid). Empyreal is a registered trademark used in connection with corn protein concentrates.

This example demonstrates at least the following: a distinct pH-buffering behavior amongst the systems studied was mainly driven by FVP and lactate/lactic presence; complete release of organic acid and soluble carbohydrates into water was attained in the first 15 min.; the FVP syrup maintained a moderate acidified-pH close to the fermentation pH ˜4.3 (Lactic acid pKa=3.73-3.79 @ 25° C.). While not wishing to be bound by theory, it is believed this pH promoted a healthy environment in the gut of the shrimp, exclusive to pathogens, and improved nutritional performance. The majority of the lactic in FVP is predominantly in a lactate form, unlike the Empyreal-LA which has predominantly the acid form. Accordingly, the lactic acid in the Empyreal-LA feed acidified the water system to a greater degree, which might explain the lower nutritional performance for the Empyreal-LA feed in shrimp.

### Materials and Methods

Materials: Empyreal 75 is a commercially available high protein corn-based gluten meal from Cargill, Inc.; FVP feed product is an Empyreal 75/FVP mixture that can be prepared by an embodiment of the process of the present invention for preparing a feed product; FVP syrup can be prepared by an embodiment of the process of the present invention for preparing a feed ingredient; and Empyreal-LA is a mixture of Empyreal 75 and Lactic Acid (LA), prepared by blending the individual components together.

Lactic acid, organic acids and pH were measured for the feed compositions as followed:

FVP Syrup Over Time (Lactic Acid Previously Reported as 153 g/L):
1. FVP was diluted to 1:10 ratio in distilled water and thoroughly mixed via gentle agitation.
2. pH of the mixture was measured at times: TO (after initial mixing), T5 min, T15 min, T30 min, T60 min, T120 min

FVP Feed Product and Empyreal 75 Over Time:
1. Empyreal-FVP or Empyreal 75 samples were diluted to 1:10 ratio in distilled water and thoroughly mixed via gentle agitation. pH of the mixture was measured.
2. Then, 15-ml aliquots of mixture were placed in 50 ml plastic tube and spun at 4,000 RPM for 5 minutes. The supernatant was filtered and run on HPLC using an Aminex HPX-87H column (300×7.8 mm) (BioRad) with a 0.6 ml/min of 0.1 M sulfuric mobile phase at 60° C. to detect organic acids.
3. Time-points of analysis: TO (after initial mixing), T5 min, T15 min, T30 min, T60 min, T120 min
4. Original concentrations were back calculated based on the 1:10 dilution.
5. The FVP Syrup was co-dried with the Empyreal at 20% dry matter (DM) to make FVP Feed Product at 8.4% DM. Calculation of the available lactic acid and pH decline over time was measured.

Empyreal-LA Over Time:

Lactic acid (PURAC Petfood 88 feed grade L-Lactic Acid) was mixed with Empyreal 75 to achieve 8.4% lactic acid on a dry basis.
1. Empyreal-LA sample was diluted to 1:10 ration in distilled water and thoroughly mixed via gentle agitation.
2. pH of the mixture was measured.
3. 15-ml aliquots of the mixture was placed into a 50 ml plastic tube and spun at 4,000 RPM for 5 minutes. The supernatant was filtered and run on HPLC using an Aminex HPX-87H column as described above.
4. Time: TO (after initial mixing), T5 min, T15 min, T30 min, T60 min, T120 min
5. Original concentrations were back calculated based on the 1:10 dilution.

Similar experiments and analyses to those described above were also conducted, but instead, DI-water was replaced with an HCl solution at pH 1.9 and 2.5.

### Results and Discussions

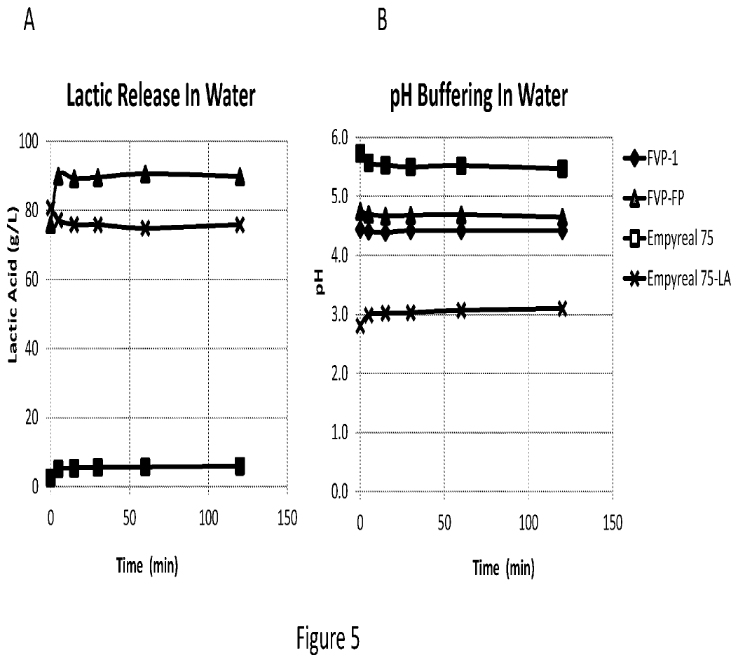

FIG. 5 is a plot showing lactic acid dissociation and pH buffering of the FVP syrup, Empyreal 75 (E-75), FVP Feed Product, and Empyreal-LA in contact with the water-based system.

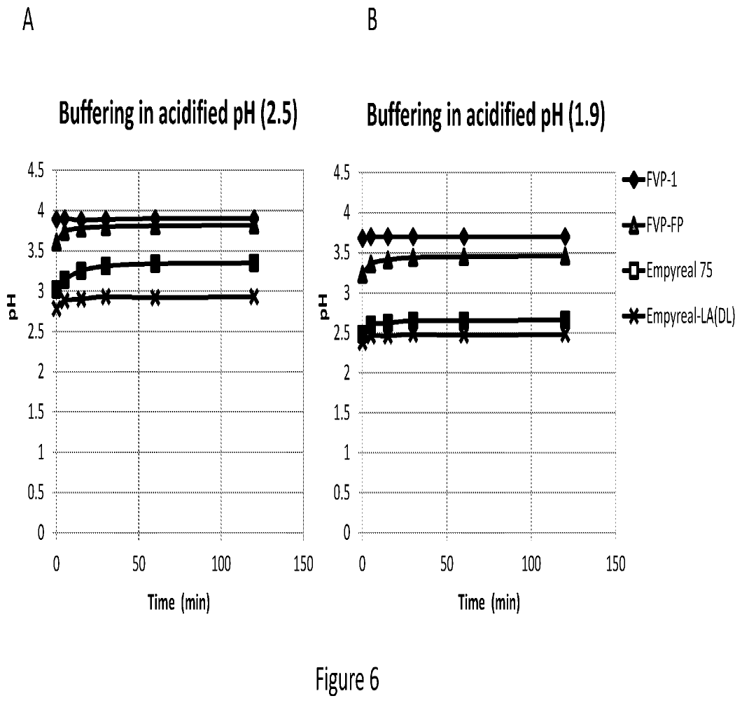

FIG. 6 is a plot showing pH buffering of FVP syrup, Empyreal 75 (E-75), FVP Feed Product, and Empyreal-LA in contact with the acid-based system (pH 1.9 and 2.5).

As illustrated in FIG. 5A, the amounts of lactic acid were ˜80 and 90 g/L for FVP Feed Product and Empyreal-LA, respectively. The control, Empyreal 75, had an initial lactic acid concentration <10 g/L. During the first five minutes of contact with water, there was a slight change in lactic concentration of all three feed products. Later, lactic concentrations reached a steady state, which indicates a quick dissociation of lactic in water. The lactic acid concentration in solution increased in Empyreal 75 and FVP Feed Product while it decreased in Empyreal-LA during the first few minutes of contact with water.

In FIG. 5B, a significant difference in pH values was detected in the three Empyreal feed systems. The pH of Empyreal 75, FVP Feed Product, and Empyreal-LA samples in water was about 5.5, 4.7, and 3.0, respectively. Empyreal 75 feed samples had the highest pH value (pH=5.5), because of its high protein and low lactic content. The intermediate pH of FVP Feed Product (pH=4.7) was slightly higher than the pH of the FVP syrup alone (pH 4.4). Both feed pHs were higher than the pKa of lactic acid (3.86), which indicates that the lactic in Empyreal 75, Empyreal-FVP, and FVP is in a lactate form. Only Empyreal-LA feed (pH=3.0) had its lactic in the acidic form. The lactate dissociated slowly in the first minutes when in contact with water and dropped the pH to reach a steady state. However, lactic acid concentration in Empyreal-LA dropped down and raised the pH. All lactic/lactate concentrations correlated very well with the pH data.

In FIGS. 6A and 6B, all three feed samples that include corn protein concentrate (Empyreal 75) showed similar behavior when in contact with acidic water (pH 1.9 and 2.5). Feed pH values increased slightly and then reached a steady state. All recorded pH values were below the pKa of lactic acid, indicating the presence of acidic form of lactic. However FVP syrup remained at exactly the lactic pKa level. The Empyreal 75 pH dropped down to levels below that of the FVP Feed Product. Inclusion of FVP syrup in the feed product maintained its buffering capacity to a level close to the lactic pKa.

FIGS. 5 and 6 show the uniqueness of FVP syrup in balancing the pH buffering capacity of one embodiment of a feed product according to the present invention (FVP Feed Product) in water (aqua-fish environment) and in acidic conditions. FVP syrup maintained a moderate acidified-pH close to the product fermentation pH (4.3) under various conditions. This moderately lower pH likely promoted conditions in the digestive tract of shrimps adverse to pathogen growth and improved their feed conversion rates (FCR) and weight gains (WG). On the other hand, Empyreal-LA feed acidified the water system, which implies that it may drive the pH of the shrimp's digestive tract beyond a healthy environment for the resident microflora, which might explain its lower nutritional performance (FCR and WG) as a shrimp diet.

### Example 2: Feeding Trial of L. vannamei with Organic Acid Corn Protein Concentrate

The trial was conducted in a clear water system with four replicates for each treatment. Pacific white shrimp (Litopenaeus vannamei) were reared for 8 weeks, starting with animals at 0.18±0.01 g.

The diets were formulated to meet all known nutritional requirements of the vannamei shrimp, with 35% crude protein and 9% crude fat. Crystalline lysine and methionine amino acids were used, along with cholesterol, lecithin and other vitamin and minerals, to balance these essential nutrients.

An embodiment of the feed product of the present invention (FVP Feed Product) was tested at two inclusion levels (12% and 24%) and compared to a reference diet which had 20% Empyreal® 75 corn protein concentrate. Two other diets were tested having a similar inclusion of FVP Feed Product (FVP FP) (12% and 24%), but the feed ingredient used was from a batch in which the fermentation of the steep liquor was not completed, and therefore had a higher amount of dextrose (Dx) and slightly lower concentration of organic acids (see Table 4).

TABLE 4
Composition of the diets used in the trial, formulated to have
35% crude protein and 9% crude fat. Values in percentage.

| | | 12% | 24% | 12% | 24% |
|---|---|---|---|---|---|
| | Empyreal | FVP | FVP | FVP | FVP |
| Diet Material | 75 Ref. | FP | FP | FP + Dx | FP + Dx |
| Empyreal 75 | 20.0 | — | — | — | — |
| Empyreal FVP | — | 12.0 | 24.0 | — | — |
| FP | | | | | |
| Empyreal FVP | — | — | — | 12.0 | 24.0 |
| FP + Dx | | | | | |
| Soybean meal | 25.7 | 40.8 | 20.7 | 40.8 | 20.7 |
| (44% C.P.) | | | | | |
| Wheat | 20.0 | 20.0 | 20.0 | 20.0 | 20.0 |
| Corn starch | 8.1 | 0.8 | 8.9 | 0.8 | 8.8 |
| Fishmeal | 8.0 | 8.0 | 8.0 | 8.0 | 8.0 |
| (menhaden) | | | | | |
| Broken rice | 5.0 | 5.0 | 5.0 | 5.0 | 5.0 |
| Fish oil | 6.0 | 6.3 | 5.9 | 6.3 | 5.9 |
| (menhaden) | | | | | |
| Premixes | 7.2 | 7.1 | 7.5 | 7.1 | 7.6 |

TABLE 5
Experimental diets proximal compositions, values in percentage.

| | Dry | Crude | Crude | Crude | |
|---|---|---|---|---|---|
| Diet | Matter | Protein | Fiber | Fat | Ash |
| Ref | 95.8 | 39.5 | 0.9 | 9.3 | 6.7 |
| 12% FVP FP | 93.4 | 32.7 | 1.4 | 9.3 | 5.9 |
| 24% FVP FP | 93.0 | 38.5 | 1.0 | 9.2 | 7.1 |
| 12% FVP FP + Dx | 90.0 | 33.5 | 1.6 | 9.4 | 6.4 |
| 24% FVP FP + Dx | 93.8 | 35.1 | 0.7 | 10.0 | 6.4 |

The diets were pre-mixed then pelletized in a commercial scale feed mill, prior to being used in the feeding trials. Due to the natural variable nutritional composition of the feed ingredients, the diets had inconsistent crude protein levels (see Table 5). For that reason, the production performance results were adjusted to the percentage of protein in the diet (see Table 6).

TABLE 6
Effect of different diets on growth performance of L. vannamei after 8 weeks,
mean initial weight ± SD, 0.18 ± 0.01 g in a clear water system at CPMC,
Gulf Shores, AL. Results adjusted to the percentage of protein in the diet (dry weight).

| | Empyreal 75 | 12% FVP | 24% FVP | 12% FVP | 24% FVP |
|---|---|---|---|---|---|
| | Reference | FP | FP | FP + Dx | FP + Dx |
| Corn protein (%) | 21.28 | 12.81 | 25.49 | 12.81 | 25.49 |
| Diet crude protein (%) | 39.5 | 32.7 | 38.5 | 33.5 | 35.1 |
| FCR¹ | 0.48^{ab} | 0.44^{a} | 0.57^{b} | 0.45^{a} | 0.54^{b} |
| Biomass² | 2.78^{ab} | 3.17^{a} | 2.57^{b} | 3.25^{a} | 2.64^{b} |
| Final weight² | 0.21^{a} | 0.22^{a} | 0.17^{b} | 0.22^{a} | 0.18^{b} |
| Weight gain² (%) | 109.42^{b} | 120.28^{a} | 96.29^{c} | 121.50^{a} | 97.09^{c} |
| Growth per week² | 0.025^{ab} | 0.027^{a} | 0.021^{b} | 0.027^{a} | 0.022^{b} |

¹as a percentage of the protein in the diet
²per unit of protein
*Different letters within rows shows significantly statistical differences (P < 0.05)

The production results show that the animals fed with diets of 12% FVP FP or FVP FP+Dx had slightly better FCR, and higher growth, final biomass, weight gain and growth per week results than the reference diet and the 24% FVP FP or FVP FP+Dx. Also, both the reference and the 12% FVP FP or FVP FP+Dx diets outperformed the 24% FVP FP or FVP FP+Dx diets, indicating that the pH and organic acid concentration in the diets reach optimum levels around the 12% FVP FP inclusion level.

The nutritional composition of the edible portions of the shrimp analyzed show a similar protein, fat, moisture and ash composition, with only the protein composition being significantly lower in the 24% FVP FP+Dx diet when compared to the reference diet (Table 7). Although, the diets with 12% inclusion of FVP FP or FVP FP+Dx had significantly lower protein contribution to the animal nutrition, which reflected on the protein gain, these diets provided the highest protein retention, indicating that the ingredient synergistically improves the digestibility and absorption of nutrients of the other ingredients that make up the diet.

TABLE 7
Whole shrimp, Litopenaeus vannamei, analysis after 8 weeks, mean initial
weight ± SD, 0.18 ± 0.01 g in a clear water system at CPMC, Gulf Shores, AL.

| | | | | | Protein | Protein | Protein |
|---|---|---|---|---|---|---|---|
| Diet | Protein | Fat | Moisture | Ash | Fed | Gain | Retention |
| Ref | 17.43^{a} | 1.64 | 77.04 | 3.07 | 3.57^{a} | 1.40^{a} | 39.20^{a} |
| 12% FVP FP | 16.71^{ab} | 1.59 | 77.69 | 3.05 | 2.93^{d} | 1.20^{b} | 40.96^{a} |
| 24% FVP FP | 16.45^{ab} | 1.51 | 77.49 | 3.08 | 3.38^{b} | 1.12^{bc} | 33.15^{b} |
| 12% FVP | 16.92^{ab} | 1.67 | 77.53 | 3.00 | 2.91^{e} | 1.23^{b} | 42.36^{a} |
| FP + Dx | | | | | | | |
| 24% FVP | 16.45^{b} | 1.79 | 77.88 | 2.91 | 3.07^{c} | 1.03^{bc} | 33.67^{b} |
| FP + Dx | | | | | | | |

*Different letters within columns shows significantly statistical differences (P < 0.05)

The results from this study show the nutritional advantages of the FVP FP in shrimp diets for optimal utilization of the available nutrients in the diet through lowering the gut pH for better mineral solubility, protein hydrolysis, and amino acids and mineral/vitamins transport through the gut epithelium. The lower concentration of phytate by the use of a phytase enzyme also aids with the nutrients availability and transport. Without wishing to be bound by theory, the organic acids present in the ingredient seem to improve proteolytic enzyme activity and be available as an energy source to the animals, which alongside with the nucleotides and nucleosides from the FVP syrup strengthen the animal's health condition, reducing the negative impacts of the stress caused by the traditional rearing methods.

### Example 3: Feed Performance of L. Vannamei with Organic Acid Corn Protein Concentrate

In this example, a corn protein concentrate/organic acid feed ingredient according to an exemplary embodiment of the present invention shows significant improvements in feed performance. The feed ingredient demonstrates a performance not seen with any currently available protein concentrate. The feed ingredient includes an array of beneficial substances for L. vannamei, such as β-glucans, mannan, nucleotides, nucleosides, organic acids, among others, that stimulates a healthy and balanced gut microbiota, which increases the gut health and overall health of animals fed with a diet including this feed ingredient.

Juvenile shrimp (mean initial weight 0.74 g) were randomly stocked into a recirculating experimental clear water culture system consisting of twelve 800-L polyethylene tanks at 30 shrimp per tank. Each diet was offered in equal amounts four times daily to shrimp in four replicate tanks for 7 weeks growth trial, with the amount offered calculated considering number of shrimp per tank and growth of 0.9 g week. Water temperature was maintained at around 27° C. and photoperiod set at 14 h light and 10 h dark.

The basal diet for the Pacific white shrimp was designed to contain 36% protein and 8% lipid using primarily plant based protein sources, with some fish meal and fish oil to maintain palatability and provide long chain polyunsaturated fatty acids. The diets were formulated to meet the nutritional requirements of shrimp (Table 8), and included one of four feed ingredients which include corn protein concentrate: 1) Empyreal® 75 corn protein concentrate; an embodiment of the feed product of the present invention (FVP FP), and two corn protein concentrates including added lactic acid (E75+Org Acids 2.2 and E75+Org Acids 7.4). The diets had similar levels of protein and lipid, the level of protein supplied by the various corn protein concentrates (CPC) was kept at a similar level, observing that the FVP FP has about 70% crude protein and Empyreal® 75 has 75% crude protein. Soybean meal and wheat flour were removed on an iso-nitrogenous basis to balance the amino acid and protein in the overall formulations.

TABLE 8
Composition of basal diet for Pacific white shrimp
formulated to contain 36% protein and 8% lipid.

| | Empyreal | FVP | E75 + Org | E75 + Org |
|---|---|---|---|---|
| | 75 | FP | Acids 2.2 | Acids 7.4 |
| CPC | 20.00 | 24.00 | 20.00 | 20.00 |
| Organic Acids | — | — | 2.20 | 7.40 |
| Soybean meal | 24.65 | 20.85 | 26.00 | 28.50 |
| fish meal | 6.00 | 6.00 | 6.00 | 6.00 |
| Fish Oil | 4.00 | 4.00 | 4.00 | 4.00 |
| Vegetable oil | 1.50 | 1.40 | 1.55 | 1.60 |
| Wheat flour | 35.00 | 35.00 | 31.40 | 23.65 |
| Vit&Min | 8.85 | 8.75 | 8.85 | 8.85 |
| premix | | | | |
| Crude Protein | 34.8 | 37.4 | 34.9 | 36.5 |
| Crude Lipid | 8.5 | 8.9 | 9.1 | 7.8 |
| Crude Fiber | 1.4 | 1.7 | 1.4 | 1.3 |
| Moisture | 9.2 | 8.2 | 8.3 | 9.1 |

TABLE 9
Response of juvenile (0.74 g) L. vannamei to test diets
over a 7 weeks growth trial in an indoor culture system.

| | In | Fin | Mean | | Gwth/ | Weight | Weight | |
|---|---|---|---|---|---|---|---|---|
| Diet | Biomass | Biomass | Fin wt | Survival | Week | Gain | Gain % | FCR |
| Empyreal 75 | 22.65 | 190.49 | 6.96 ^{b} | 91.11 | 0.89 ^{b} | 6.20 ^{b} | 822.86 | 1.88 ^{b} |
| FVPFP | 21.84 | 205.61 | 8.12 ^{a} | 84.44 | 1.06 ^{a} | 7.39 ^{a} | 1015.57 | 1.57 ^{a} |
| E75 + Org | 21.85 | 189.04 | 7.18 ^{b} | 87.78 | 0.92 ^{b} | 6.45 ^{b} | 889.24 | 1.80 ^{b} |
| Acids 2.2 | | | | | | | | |
| E75 + Org | 22.12 | 192.23 | 6.87 ^{b} | 93.33 | 0.88 ^{b} | 6.13 ^{b} | 838.61 | 1.90 ^{b} |
| Acids 7.4 | | | | | | | | |
| P-value | 0.8833 | 0.5205 | 0.0044 | 0.1865 | 0.0058 | 0.0058 | 0.0920 | 0.0092 |

* Different letters indicate significant statistical differences (P < 0.05).

To get the full benefit from a diet, the ingredients must be well digested and absorbed by the animal. The best way to achieve this goal is by having a balanced gut pH and microbiota, which aid in the digestion of the diet, endogenously produce key nutrients for its host (in this case the animal being produced), and fight pathogens. Reducing the pH of the gut and providing key nutrients to the microbiota is the optimum way to maintain a healthy gut environment and maintain the microbial population.

The diets were analyzed to make sure that the pH values were being lowered, this way contributing to the acidic environment. For such analysis, 5 g of feed (as is) were added to 100 ml of deionized water and the pH was checked at time intervals with a hand-held pH meter.

TABLE 10
Measured pH in feed pellets used during the trial in
different moments in time (values are averages of triplicate samples).
Whole Feed Pellets

| | Empyreal | FVP | E75 + Org | E75 + Org | |
|---|---|---|---|---|---|
| Time | 75 | FP | Acids 2.2 | Acids 7.4 | P-value |
| 1 | 6.81 ^{a} | 6.22 ^{b} | 5.96 ^{c} | 4.97 ^{d} | <0.0001 |
| 15 | 5.71 ^{a} | 5.36 ^{b} | 5.38 ^{b} | 4.53 ^{c} | <0.0001 |
| 30 | 5.49 ^{a} | 5.24 ^{b} | 5.21 ^{b} | 4.48 ^{c} | <0.0001 |
| 60 | 5.41 ^{a} | 5.10 ^{b} | 5.13 ^{b} | 4.44 ^{c} | <0.0001 |
| 120 | 5.35 ^{a} | 5.19 ^{b} | 5.11 ^{b} | 4.43 ^{c} | <0.0001 |

* Different letters indicate significant statistical differences (P < 0.05).

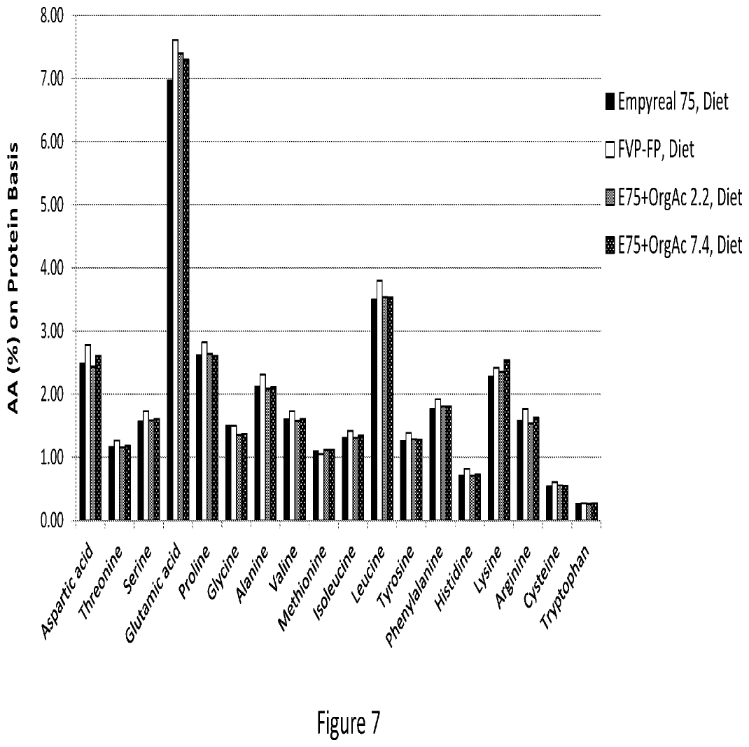

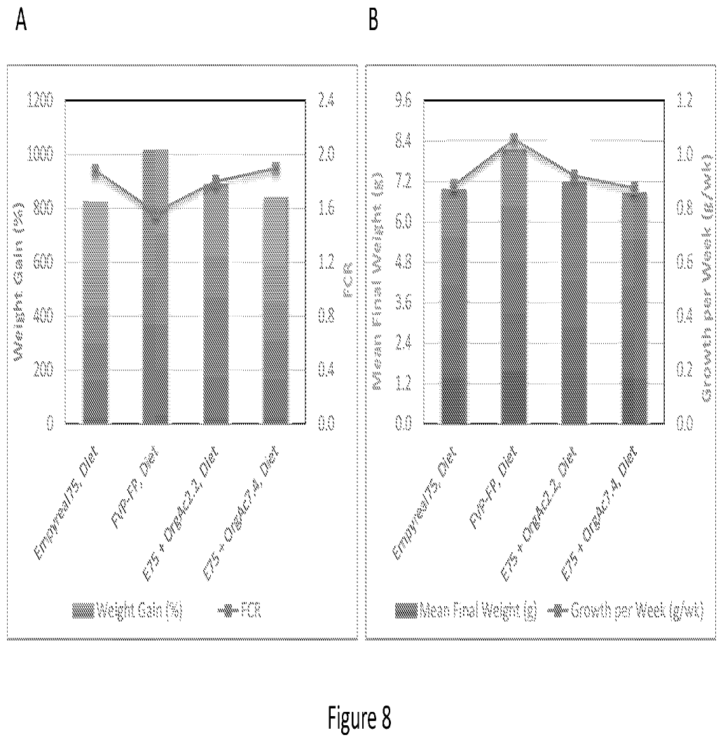

The amino acid profiles of the diets studied is shown in FIG. 7. The effects of the diets on the shrimp are shown in FIGS. 8A and 8B. The benefits of the FVP FP can be seen by 16% increased weight gain and more than 19% better feed conversion of the animals, as compared to the reference diet; as well as aiding during extrusion/pelleting and improved pellet quality. The slight acidic pH on the final diet also contributes to the extended shelf life of the ration due to the inhibition of bacterial and mold growth on the kibble during storage.

The disclosures of each and every patent, patent application, or publication cited herein are hereby incorporated by reference in their entirety. While this invention has been disclosed with reference to specific embodiments, other embodiments and variations of this invention may be devised by others skilled in the art without departing from the true spirit and scope of the invention. The appended claims are intended to be construed to include all such embodiments and variations.

1. An animal feed ingredient, comprising:
one or more organic acids,
one or more proteins,
phosphorus, and
less than 0.6 wt % phytic acid.

2. The feed ingredient of claim 1, wherein the one or more organic acids are selected from the group consisting of lactic acid, formic acid, propionic acid, fumaric acid, citric acid, butyric acid, gluconic acid, itaconic acid, pyruvic acid, salts thereof, and any combination of these organic acids or salts thereof.

3. The feed ingredient of claim 1, wherein the one or more organic acids are present in an amount suitable for reducing the gastric pH of an animal.

4. The feed ingredient of claim 1, wherein the one or more organic acids are present in an amount of about 45 to 50 wt % dry basis.

5. The feed ingredient of claim 1, wherein the one or more proteins comprise corn protein.

6. The feed ingredient of claim 1, wherein the one or more proteins are present in an amount of about 25 to 35 wt % dry basis.

7. The feed ingredient of claim 1, comprising 4.0 to 6.0 wt % free phosphate on dry basis.

8. The feed ingredient of claim 1, comprising 38 to 43 wt % lactic acid on dry basis.

9. The feed ingredient of claim 1, comprising less than 2 wt % of sugars on dry basis.

10. The feed ingredient of claim 1, wherein the feed ingredient is at least 40% dry solids.

11. An animal feed product, comprising:
the feed ingredient of claim 1.

12. The feed product of claim 11, further comprising corn protein concentrate.

13. The feed product of claim 11, further comprising corn gluten meal.

14. The feed product of claim 11, wherein the phytic acid content is less than 0.6 wt % dry basis.

15. The feed product of claim 11, wherein the feed product has an organic acid content of about 8.0 to 9.0 wt % dry basis.

16. The feed product of claim 11, comprising 72 to 76 wt % protein dry basis.

17. The feed product of claim 11, comprising 3.0 to 3.6 wt % lysine dry basis.

18. The feed product of claim 11, comprising 6 to 8 wt % lactic acid dry basis.

19. The feed product of claim 11, comprising 4.0 to 6.0 wt % free phosphate on dry basis.

20. The feed product of claim 11, comprising less than 2 wt % of sugars on dry basis.

21-52. (canceled)
